(19) United States
(12) Patent Application Publication
(10) Pub. No.: US 2015/0295465 A1
(43) Pub. Date: Oct. 15, 2015

(54) DIFFUSION BARRIER LAYER FOR CANS

(71) Applicant: SIEMENS AKTIENGESELLSCHAFT, München (DE)

(72) Inventor: Ralf Bode, Moers (DE)

(21) Appl. No.: 14/437,837

(22) PCT Filed: Sep. 25, 2013
(86) PCT No.: PCT/EP2013/069925

§ 371 Date: Apr. 23, 2015

(30) Foreign Application Priority Data
Oct. 25, 2012 (DE) 102012219514.9

(51) Int. Cl. H02K 5/128; H02K 15/14; H02K 15/12

(52) U.S. Cl. CPC H02K 5/128; H02K 15/12; H02K 15/14; H02K 2005/1287

(57) ABSTRACT

A can for an electric motor, especially for an electric motor in a compressor, the can be at least partially provided with an ethyl silicate coating is provided. A method for producing a can of this kind is also provided.

### CROSS-REFERENCE TO RELATED APPLICATIONS

This application claims priority to PCT Application No. PCT/EP2013069925 having a filing date of Sep. 25, 2013, based off of German Application No. DE 102012219514.9 having a filing date of Oct. 25, 2015, the entire contents of which are hereby incorporated by reference.

### FIELD OF TECHNOLOGY

The following relates to embodiments of a diffusion barrier layer for cans for electric motors.

### BACKGROUND

Electric motors having a can are found in particular in hermetically sealed compressors into which the electric motor serving as a drive machine is integrated. The can is a tubular component which is located in the air gap of the electric motor, as is known from WO 2004/036052.

One potential construction of a can is a usual tube which is wrapped with continuous glass fibers. The glass fibers here run in an epoxy resin or are at least coated with an epoxy resin. Typically, the epoxy resin is cured here under the influence of temperature. The tube, which in many cases is referred to as a mandrel, which is wrapped with the glass fibers may be removed again after wrapping and curing. On account of the cured epoxy resin matrix, permeation of gases, such as methane, carbon dioxide, and hydrogen sulfide can be prevented. Despite the high quality of cans of this type, permeation does occur at times, in particular in the case of high pressure differentials.

DE 101 06 043 A1 discloses a method according to which a can of plastic for a canned pump, in particular for a heating or cooling water pump, preferably for the automotive sector, made from a pre-fabricated tube having an additional layer of a reinforced material is provided with threads of carbon, for example by wrapping.

### SUMMARY

An aspect relates to providing a can for an electric motor, wherein permeation is low.

It has been recognized that a can for an electric motor, in particular for an electric motor in a compressor, has to be provided, wherein the can is at least partially provided with an ethyl silicate coating.

The proposed ethyl silicate coating eliminates permeation of gases very well. Apart from the property as an excellent diffusion barrier, the ethyl silicate coating also has a high surface hardness. This high surface hardness also prevents undesirable erosion by hard particles in the gas streaming past. Above all, this is gas streaming through the inside of the can. Insofar as high gas tightness is mentioned in the following, this generally does not refer to conventional tightness which eliminates a throughflow of gas on account of pressure differentials. It is also advantageous in the case of the ethyl silicate coating that the gas cannot make its way through the can on account of diffusion processes. Above all, this is important in the case of toxic and/or heavily corrosive gases, where particular attention has to be paid to also eliminating the exit of small amounts. It should be additionally mentioned that gas tightness does not inevitably mean that no gas whatsoever may pass through. This is aspired to and is also frequently achieved in individual cases, above all in the case of extreme conditions, but it is possible for minor amounts of gas to make their way through a wall of the can even when employing the present embodiments of the invention.

In one embodiment, a can is provided in which an element which is wrappable by at least one wrapped element is present. The wrappable element in most cases is a mandrel. The wrappable element can be removed again after wrapping. It is thus not necessary for the wrappable element to remain in the finished can.

Various materials which are sufficiently stable and flexible may be considered as a wrapped element. Moreover, the wrapped element must withstand the conditions in the planned application of the electric motor, such as corrosive or toxic gases in a compressor.

Fibers are a tried and tested wrapped element. Fibers made from glass or oxide ceramics have proven to be particularly suitable here. In general, it is important for the fiber to be chemically compatible with the ethyl silicate coating. Fibers having a diameter of 8 μm to 50 μm have proven to be geometrically useful. The length of the fibers depends on the size of the can. Continuous fibers are typically used.

In one embodiment of the invention, the wrapped element is located in a matrix of cured material, for example in an epoxy resin matrix. As is illustrated in detail in the context of the method for manufacturing, the can which will be described below, the epoxy resin matrix may be provided by curing fibers which are impregnated in epoxy resin. The ethyl silicate coating may be applied onto the matrix of cured material. In this way, a known can could be provided with an epoxy resin matrix having an ethyl silicate coating, for instance. This permits simple manufacturing of a very stable and well-sealed can.

It is provided in one embodiment that the ethyl silicate coating has a dry-film layer thickness of 50 μm to 150 μm, preferably about 100 μm. As a rule, a dry-film layer thickness of 50 μm should not be undershot, since gas tightness and stability are otherwise not reliably guaranteed. Dry-film layer thicknesses of more than 150 μm entail high complexity and offer minor additional benefits in terms of stability and gas tightness. Moreover, high dry-film layer thicknesses bear the risk of decollation, also referred to as delamination. The ethyl silicate coating may be formed from a plurality of individual ethyl silicate layers.

In one embodiment, the wrapping formed by the wrapped element, that is to say mostly the fiber, has a layer thickness of 2 mm to 6 mm, preferably 4 mm. Usually, the wrapped element is wrapped in multiple layers around the wrappable element.

As explained above, one advantage of the ethyl silicate coating is the reduction of undesirable erosion by hard particles in the gas streaming past. The gas usually streams on the inner side, so that the ethyl silicate coating also and specifically should be applied to the inner side.

However, it is to be stated in this context that it would be conceivable for the ethyl silicate coating to be directly applied to the inner side onto the wrappable element if the wrappable element is not to be removed. However, in this case a wrappable element which can be coated with ethyl silicate has to be selected.

Various materials can be considered for the wrappable element. Since stability and gas tightness are guaranteed by the wrapping, by the typically provided matrix of cured material and by the ethyl silicate coating, no high requirements are to be placed on the wrappable element. A usual tube or a usual cylinder of plastic or steel may be employed, for instance. It is merely important that said wrappable element mechanically withstands the wrapping. These limited requirements are particularly sufficient if the wrappable element is removed again after the matrix has cured. However, said wrappable element must withstand the temperature which usually prevails during curing.

Embodiments of the invention also relates to a method for manufacturing a can, in particular a can as described above. To this end, a wrappable element is to be initially provided. The wrappable element, as a rule a tube or a cylinder, is to be wrapped with a wrapped element, as a rule a fiber which is impregnated with a curable material, for instance resin. An ethyl silicate coating makes available stability and gas tightness. As illustrated above, an ethyl silicate coating on both sides is preferable, in order to benefit from the ethyl silicate coating also on the inner side.

Liquid ethyl silicate is applied, for example brushed or sprayed thereon, in order to apply the ethyl silicate coating. Curing is performed by way of air humidity. After curing, the molecular structure approximately corresponds to that of pebble stones. On account thereof, the high gas tightness and the high surface hardness are achieved.

It is provided in one embodiment of the manufacturing method that the wrapped element which is impregnated with the curable material is to cured. Although as a rule an impregnated wrapped element is used for wrapping, wrapping could also take place first and thereafter impregnating, for instance by brushing or spraying with curable material. It is possible for the wrappable element to be removed from the cured matrix in which the wrapped element is located after curing.

It is provided in one embodiment of the manufacturing method that the ethyl silicate coating is applied in a plurality of layers. In this way, the individual layers may be very thin, such that the individual layers can cure very well. In the case of an excessively thick layer there is the risk that curing is performed on the side of the layer which faces the ambient air, and that regions which are farther inside do not cure any more. Above all, this may be at the expense of stability. Two layers have proven to be a sensible compromise between a stable coating and a reasonable complexity in manufacturing.

### BRIEF DESCRIPTION

Some of the embodiments will be described in detail, with reference to the following figures, wherein like designations denote like members, wherein:

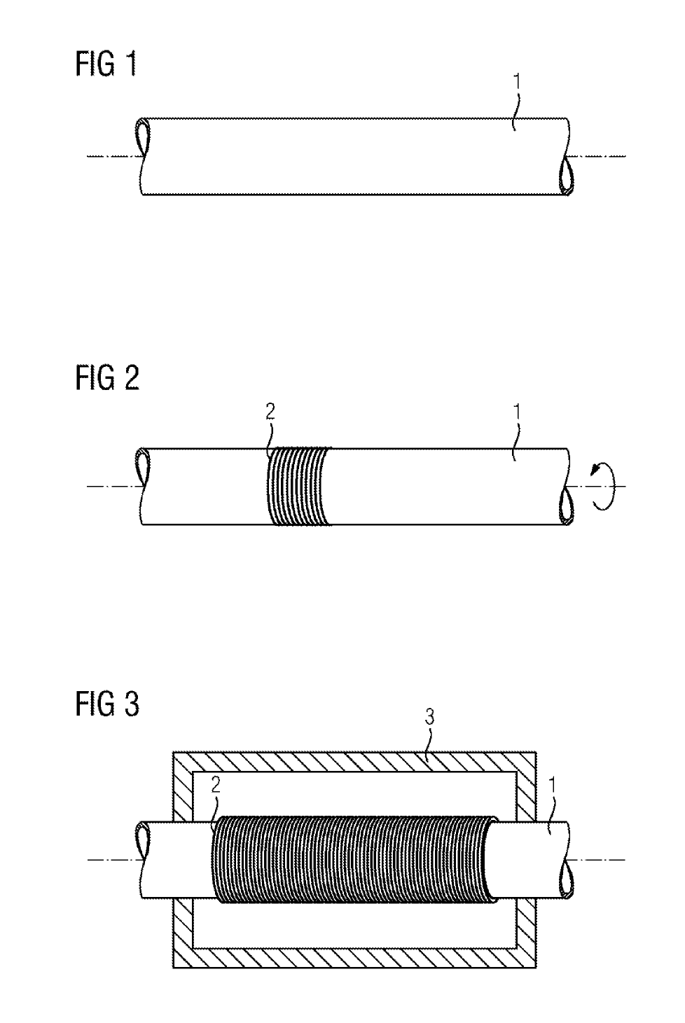

FIG. 1 shows an embodiment of a mandrel which is provided for wrapping;

FIG. 2 shows the wrapping of an embodiment of the mandrel with a fiber;

FIG. 3 shows curing of an embodiment of the resin-impregnated fiber in an oven;

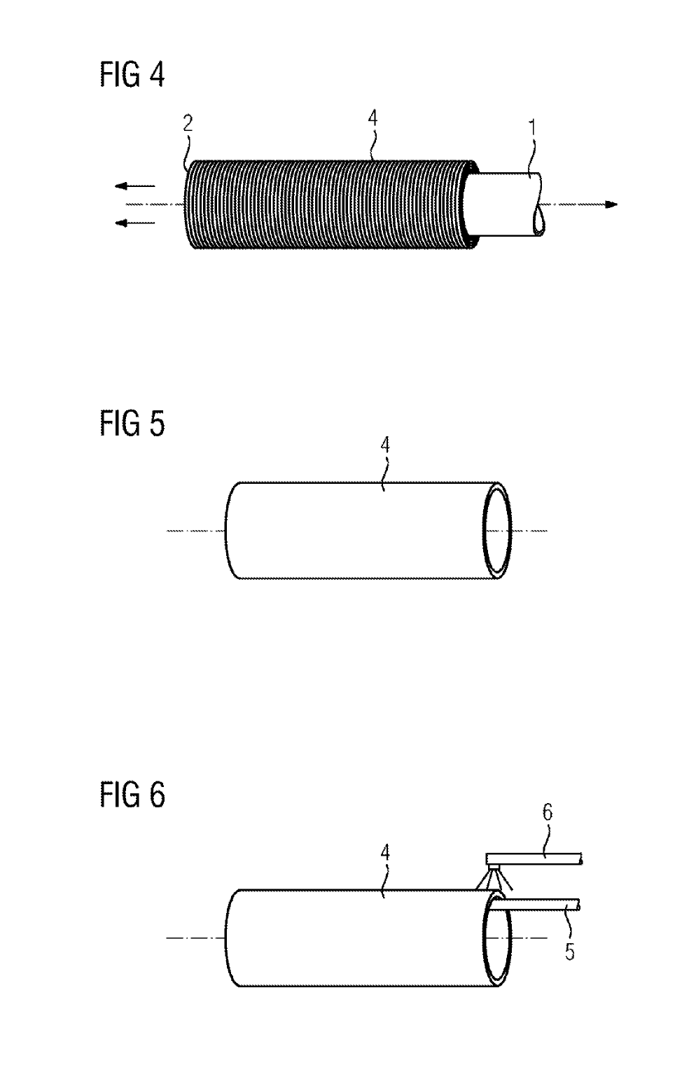

FIG. 4 shows the removal of an embodiment of the mandrel;

FIG. 5 shows an embodiment of the-a can which has been sanded on both sides and has not yet been coated; and

FIG. 6 shows an embodiment of the coating with ethyl silicate.

FIG. 1 shows a mandrel 1 as the wrappable element. As can be seen in FIG. 2, the mandrel 1 is tightly wrapped with a fiber 2. The fiber 2 is preferably a glass or ceramic fiber. The fiber 2 is impregnated with curable material, resin having been selected therefor in the present case.

The mandrel 1 which is wrapped with the impregnated fiber 2 is then inserted into an oven 3 which is shown in a schematic manner. There, heat is supplied, such that a temperature which is required for curing is obtained. After the required curing time the cured matrix 4, in which the fiber 2 is located, is removed together with the mandrel which surrounds it from the oven 3. As is shown in FIG. 4, the mandrel 1 is laterally pulled out from the matrix 4.

In order to obtain smooth surfaces of the presently required dimension, the matrix 4 obtained, together with the fiber 2 located therein, is sanded on all sides, such that a can shown in FIG. 5 is obtained.

As is shown in FIG. 6, coating is performed with ethyl silicate. Here, employment of an inner coating installation 5 and of an outer coating installation 6 is shown. In this way, an ethyl silicate coating is applied onto the inner side and onto the outer side. Here, that much ethyl silicate is applied that after curing, which is performed with the aid of the air humidity of the ambient air, in each case a layer thickness of about 50 μm is configured. This process is repeated after curing, such that on the inner side and on the outer side of the matrix 4 an ethyl silicate coating having a thickness of about 100 μm is present. In this way, a can having high gas tightness and stability is achieved.

The can achieved in this way may be employed in a device according to WO 2004/036052, for instance.

Although the invention has been illustrated and described in more detail by the preferred exemplary embodiment, the invention is not limited by the disclosed examples, and other variants may be derived therefrom by a person skilled in the art without departing from the scope of the invention.

1. A can for an electric motor, in a compressor, wherein the can is at least partially provided with an ethyl silicate coating.

2. The can as claimed in claim 1, wherein the can is produced by wrapping a wrappable element with at least one wrapped element, wherein the wrappable element is removed, such that the wrappable element does not remain as an element of the can.

3. The can as claimed in claim 2, wherein the at least one wrapped element is a fiber.

4. The can as claimed in claim 2, wherein the at least one wrapped element is located in a matrix of cured material.

5. The can as claimed in claim 1, wherein the ethyl silicate coating has a dry-film layer thickness of 50 μm to 150 μm.

6. The can as claimed in claim 1, wherein a wrapping which is formed by the wrapped element has a layer thickness of 2 mm to 6 mm.

7. The can as claimed in claim 2, wherein the wrappable element is composed of or contains a material, the material being a plastic or a steel alloy.

8. A method for manufacturing a can as claimed in claim 1, comprising the following steps:
providing at least one wrappable element;
wrapping the at least one wrappable element with a wrapped element; and
coating the wrapped element with an ethyl silicate coating.

9. The method as claimed in claim 8, further comprising:
impregnating the wrapped element with acurable material;
curing the impregnated wrapped element, wherein curing is performed by a suitable temperature; and
removing the at least one wrappable element from the wrapped element.

10. The method as claimed in claim 8, wherein the ethyl silicate coating is applied in a plurality of layers.

11. The can as claimed in claim 4, wherein the matrix of cured material is an epoxy resin matrix.

12. The can as claimed in claim 5, wherein the dry-film thickness is about 100 μm.

13. The can as claimed in claim 6, wherein the layer thickness is 4 mm.
